(19) United States
(12) Patent Application Publication
(10) Pub. No.: US 2003/0156038 A1
(43) Pub. Date: Aug. 21, 2003

(54) LED display and method to create same

(76) Inventors: Shannon G. Hankins, Tulsa, OK (US); Phillip R. Hildebrand, Tulsa, OK (US); John T. Rathbone, Broken Arrow, OK (US)

Correspondence Address: BRENT CAPEHART, 1861 EAST 15TH ST., P.O. BOX 4126, TULSA, OK, 74104, US

(21) Appl. No.: 10/366,052

(22) Filed: Feb. 13, 2003

Related U.S. Application Data
(60) Provisional application No. 60/357,547, filed on Feb. 15, 2002.

(51) Int. Cl. G08B 5/22

(52) U.S. Cl. 340/815.45; 340/691.6

(57) ABSTRACT

The present invention comprises a communication device having an light emitting diode (LED) display for displaying a text message and/or one or more images, wherein the LED display is of an ultra-miniature design; a programmable circuit connected to the LED display; a power supply to power the LED display and the programmable circuit; and a frame for holding the LED display, the programmable circuit and the power supply.

### REFERENCE TO PENDING APPLICATIONS

This application claims the benefit of U.S. Provisional Patent Application Serial No. 60/357,547 filed Feb. 15, 2002 entitled LED DISPLAY AND METHOD TO CREATE SAME.

### REFERENCE TO MICROFICHE APPENDIX

This application is not referenced in any microfiche appendix.

### BACKGROUND OF THE INVENTION

1. Field of the Invention

The invention relates to light emitting diode (LED) displays for use with a communication device removeably mountable upon an individual, vehicle or other object, and a method related thereto.

2. Background

Conveying thoughts, concepts and other information between two or more persons occurs everyday. Through verbal and non-verbal means, these thoughts, concepts and other information are received by the receiving audience. To insure that one's message is accurately received, that message must be accurately conveyed.

Additionally, a particular message or other information can be conveyed over a distance. A billboard is an example of how information can be conveyed in this manner. At times, however, a message is not effectively received by a target audience due to the message's surroundings. For example, a store is having a sale on a particular item. The notice advertising the sale is placed at the entrance of the store along with other notices and advertisements. It may or may not been seen by the store's patrons, thus reducing the effectiveness of the notice.

Various electronic signs have been used to convey messages. Most of these signs, however, are large in scale and are not suited for small scale usage upon an individual, vehicle or other similarly situation object.

One attempt at using an electronic sign on an individual is disclosed in U.S. Pat. No. 6,288,701 issued to Karp. This device utilizes a liquid crystal display (LCD) to display a text message. However, this device has some serious performance issues. The main LCD displays are either a backlit LCD or a reflective LCD. The backlit LCD requires a secondary lighting source to operate. This allows the display to be seen in low light conditions but is difficult to see in bright light conditions. Further, because the backlit LCD requires a secondary light source, it requires a relatively high amount of power in order to operate. The reflective LCD operates off the ambient lighting surrounding the LCD. A mirror reflects the ambient light which causes the LCD to display the desired text. Accordingly, the reflective LCD can be seen in bright light conditions but not in low light conditions. Further, due to the reflective LCD's mirror, the LCD blends into its surroundings. This makes the reflective LCD difficult to see for a distance.

There is a present need to increase the ability to convey a message through non-verbal communication. This ability would assist in accurately conveying thoughts, concepts and other information, along with increasing the distance of information conveyance.

Additionally, efforts are ongoing in the art to improve and enhance the appearance of advertising. Those in the art continue to search for new, improved ways and devices for using various apparatus and methods for advertising, promotion, identification, and for communicating other types of expression.

### BRIEF SUMMARY OF THE INVENTION

The present invention satisfies the needs discussed above. The present invention is generally directed toward a light emitting diode (LED) display, more specifically toward a light emitting diode (LED) display for use with a communication device removeably mountable upon an individual, vehicle, or other objects, and method related thereto.

As used herein, the term LED refers to all light emitting diodes which are created using the various known methods of creation.

In one aspect, the present invention provides a communication device comprising an LED display for displaying a text message and/or one or more images. The LED display is of an ultra-miniature design. A programmable circuit is connected to the LED display. A power supply is provided to power the LED display and programmable circuit. The LED display, programmable circuit and power source are located within a frame.

The LED light source is a more effective light source. It has its own light source, thus not being dependant upon a secondary light source or ambient light. Further, due to having its own light source, it can be seen at a distance. Thus it is able to draw more attention to the message being transmitted.

In another aspect, the present invention provides a communication device comprising a LED display as set forth above wherein the LED is a surface mounted LED. This allows the LED to be installed more easily.

In another aspect, the present invention provides a communication device comprising a LED display as set forth above wherein the text message and/or one or more images can be preprogrammed or user programmed. This allows for a message or image to be either non-modifiable or modifiable by the user.

In another aspect, the present invention provides a communication device comprising a LED display as set forth above wherein the LED display for displaying a text message and/or one or more images is further defines as providing a scrolling text message.

In another aspect, the present invention provides a communication device comprising a LED display as set forth above wherein the power supply is a rechargeable battery.

In another aspect, the present invention provides a communication device comprising a LED display as set forth above wherein the frame is a badge to be worn by and mountable on an individual. This badge can be a badge showing a text message, an image or a combination of the two by an individual.

In another aspect, the present invention provides a communication device comprising a LED display as set forth above wherein the frame is a piece of body jewelry to be removably mountable on an individual via a piercing of the individual's skin. This aspect allows for the present invention to be used as a piece of body jewelry, such as, but not limited to, an earrings or belly-button jewelry.

In another aspect, the present invention provides a communication device comprising a LED display as set forth above wherein the frame is a vehicle license plate frame. This aspect allows the present invention to be used in conjunction with a vehicle, such as, but not limited to, an automobile as motorcycle.

When the present invention is utilized in conjunction with a vehicle, another aspect provides for the device to become activated when the vehicle's brakes are applied and deactivated when the vehicle's brakes are released.

In another aspect, the present invention provides a communication device as set forth above further comprising a communication link between the programmable circuit and an external programming source for programming the circuit. This allows the text message or image to be edited or otherwise modified. This communication link can be, but not limited to, including USB wire, infrared, visible light, RF, magnet field modulation and audible tone. The external programming source can be, but not limited to, a computer, a hand-held, personal data assistant device or a cell phone.

In another aspect, the present invention provides a method comprising the steps of retrieving from an external programming source data corresponding to information to be displayed by a LED display located within a removably mountable communication device and displaying said information within said LED display. In this aspect the LED display is of an ultra-miniature design. Further, this method allows for the displaying of the information to be defined as scrolling the information within the LED display.

Upon reading the above description, various alternative embodiments will become obvious to those skilled in the art. These embodiments are to be considered within the scope and spirit of the subject invention, which is only to be limited by the claims which follow and their equivalents.

Further objects, features and advantages of the present invention will be apparent to those skilled in the art upon reference to the accompanying drawings and upon reading the following description of the preferred embodiments.

### BRIEF DESCRIPTION OF THE DRAWINGS

FIG. 1 is a front view of an embodiment of the present invention.

FIG. 2 is a rear view of an embodiment of the present invention

FIG. 3 is a side view of an embodiment of the present invention.

FIG. 4 is a front view of an additional embodiment of the present invention.

FIG. 5 is a rear view of an additional embodiment of the present invention.

FIG. 6 is a front view of a third embodiment of the present invention.

FIG. 7 is a rear view of a third embodiment of the present invention.

### DETAILED DESCRIPTION OF THE PREFERRED EMBODIMENTS

Before explaining the present invention in detail, it is to be understood that the invention is not limited in its application to the details of the construction and arrangement of parts illustrated in the accompanying drawings. The invention is capable of other embodiments and of being practiced or carried out in a variety of ways. It is to be understood that the phraseology and terminology employed herein are for the purpose of description and not of limitation.

As shown in the FIGS. 1-3, an embodiment 10 of the inventive communication device comprising an LED display 14 for displaying a text message 24 and/or one or more images 26. The text message 24 and/or image 26 can be pre-programmed or user programmed. This allows for a message or image to be either non-modifiable or modifiable by the user. Further, device 10 is capable of scrolling the text message 24 and/or image 26. While text message 24 and image 26 are shown in the Figures together, one skilled in the art will recognize that either the text message 24 or the image 26 could appear individually.

The LED display 14 is of an ultra-miniature design. One embodiment of the LED is that of a surface mounted LED, as opposed to a through-hole LED. The surface mounted LED is easier to install that the through-hole LED, thus improving the installation time for the inventive device.

The LED light source is a more effective light source than the LCD light source. By having its own light source, it is not dependant upon a secondary light source or ambient light. Further, due to having its own light source, it can be seen at a distance. Thus it is able to draw more attention to the message being transmitted, irrespective to the surrounding lighting conditions.

A programmable circuit 16 is connected to the LED display 14. A locally located battery 18 is the power supply to power the LED display 14 and programmable circuit 16. Those skilled in the art will recognize that battery 18 is for illustrative purposes and is not meant to be limiting. Other types of power sources include, but are not limited, to a remote power source. A lens 28 is fitted over LED display 14.

The LED display 14, programmable circuit 16 and power source 18 are located within a frame 12. Frame 12 has an opening 13 of the dimensions of LED display 14. Opening 13 allows LED display to be seen. Embodiment 10 of the present invention illustrates frame 12 to be in the form of a badge to be worn by and mountable on an individual. Those skilled in the art will recognize that this frame style is for illustrative purposes and is not meant to be limiting.

When frame 12 is secured to an individual by a securing mechanism, such as a magnet 20. Those skilled in the art will recognize that this securing mechanism is for illustrative purposes and is not meant to be limiting.

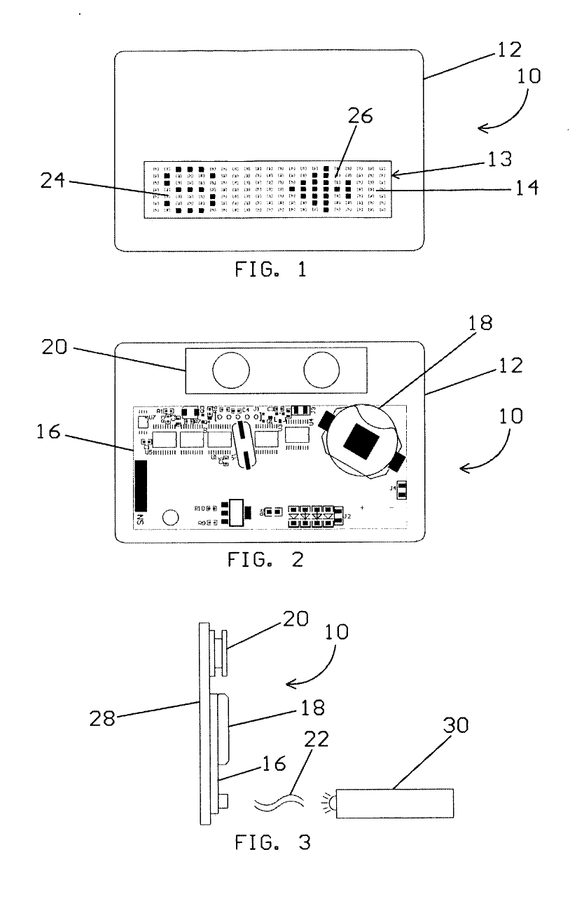

Device 10 can also include a communication link between the programmable circuit 16 and an external programming source, not shown. This communication link allows for the programming and reprogramming of programmable circuit 16. This allows the text message 24 and/or image 26 to be edited or otherwise modified. This communication link can be, but not limited to, including USB wire, infrared, visible light, RF, magnet field modulation and audible tone. As shown in FIG. 3, an infrared signal 22 is being sent to device 10 by an external programming source 30. The external programming source 30 can be, but not limited to, a computer, a hand-held, personal data assistant device or a cell phone. Those skilled in the art will recognize that these examples are for illustrative purposes and is not meant to be limiting.

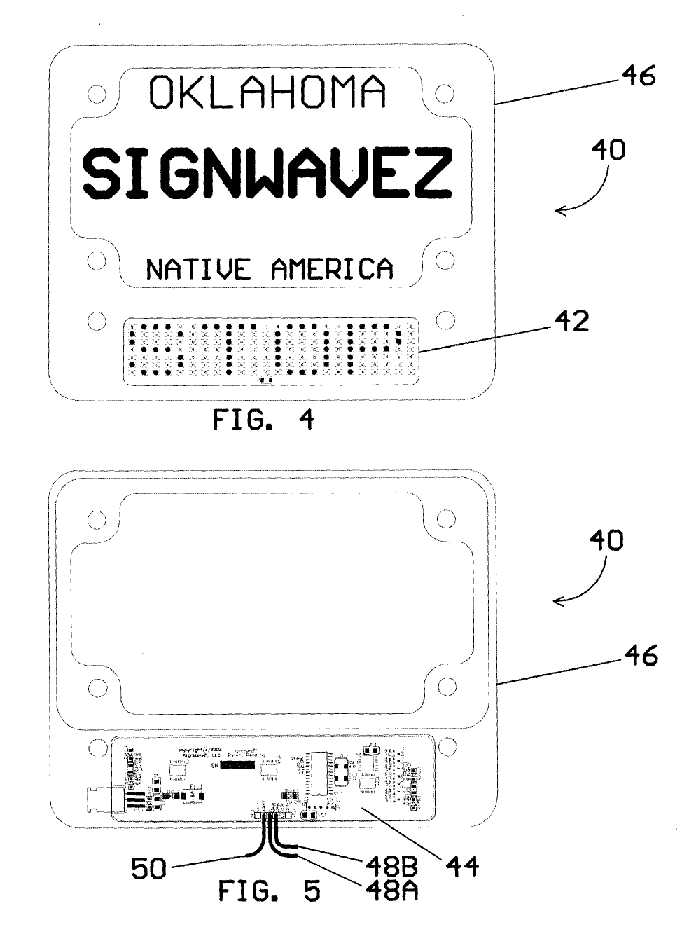

As shown in the FIGS. 4-5, an embodiment 40 of the inventive communication device is shown. The basic components of this embodiment relate to the components of the above embodiment. However, this embodiment utilizes a frame 46 which is the design of a vehicle license plate frame. This embodiment 40 includes a LED display 42 and programmable circuitry 44, both of which are similar in capabilities as discussed above. The power source for this embodiment is provided by the vehicle's power source not shown via power leads 48A and 48B.

An additional feature to this embodiment includes the activation of LED display 42 when the vehicle's brakes are applied and deactivated when the vehicle's brakes are released. This embodiment reacts to signals received from the vehicle's brake system via a brake lead 50.

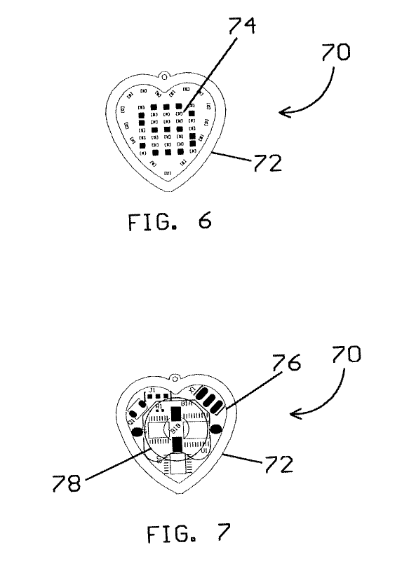

As shown in the FIGS. 6-7, an embodiment 70 of the inventive communication device is shown. The basic components of this embodiment relate to the components of the above embodiment. However, this embodiment utilizes a frame 72 which is the design of a piece of body jewelry. This embodiment 70 includes a LED display 74 and programmable circuitry 76, both of which are similar in capabilities as discussed above. The power source for this embodiment is provided by a battery 78.

Illustrated in FIGS. 6-7, frame 72 is in a heart-shaped design. This frame is removably mounted to an individual by a connection hoop, not shown. It is understood that those skilled in the art would recognize that the design of frame 72 is merely illustrative and not meant to be limiting. Frame 72 can take the shape of other designs while being connected to an individual by other connection devices.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification, but is to be limited only by the scope of the attached claims, including the full range of equivalency to which each element thereof is entitled.

What is claimed is:

1. A removably mountable communication device comprising:
a LED display for displaying a text message and/or one or more images, wherein said LED display is of an ultra-miniature design;
a programmable circuit connected to said LED display;
a frame for holding said LED display and said programmable circuit; and
a power supply to power said LED display and said programmable circuit.

2. The removably mountable communication device of claim 1, wherein said power supply is located within said frame.

3. The removably mountable communication device of claim 1, wherein said text message and/or said image are pre-programmed.

4. The removably mountable communication device of claim 1, wherein said text message and/or said image are user programmed.

5. The removably mountable communication device of claim 1, wherein said LED display for displaying a text message and/or one or more images is further defines as providing a scrolling text message.

6. The removably mountable communication device of claim 1, wherein said power supply is a rechargeable battery.

7. The removably mountable communication device of claim 1, wherein said frame is a badge to be worn by and mountable on an individual.

8. The removably mountable communication device of claim 1, wherein said frame is a piece of body jewelry to be removably mountable on an individual via a piercing of said individual's skin.

9. The removably mountable communication device of claim 1, wherein said frame is a vehicle license plate frame.

10. The removably mountable communication device of claim 9, wherein said LED display is activated when said vehicle's brakes are applied and deactivated when said vehicle's brakes are released.

11. The removably mountable communication device of claim 1 further comprising a communication link between said programmable circuit and an external programming source for programming said circuit.

12. The removably mountable communication device of claim 11, wherein said communication link is a USB wire.

13. The removably mountable communication device of claim 11, wherein said communication link is through infrared transfer technology.

14. The removably mountable communication device of claim 11, wherein said external programming source is a computer.

15. The removably mountable communication device of claim 11, wherein said external programming source is a hand-held, personal data assistant device.

16. The removably mountable communication device of claim 11, wherein said external programming source is a cell phone.

17. A method in a removably mountable communication device, the method comprising:
retrieving from an external programming source data corresponding to information to be displayed by a LED display located within a removably mountable communication device having, wherein said LED display is of an ultra-miniature design; and
displaying said information within said LED display.

18. The method of claim 17 wherein the step of displaying is further defined as scrolling said information within said LED display.
